(19) United States
(12) Patent Application Publication
(10) Pub. No.: US 2020/0118202 A1
(43) Pub. Date: Apr. 16, 2020

(54) RENTAL MANAGEMENT SYSTEM, RENTAL MANAGEMENT METHOD, AND STORAGE MEDIUM

(71) Applicant: HONDA MOTOR CO., LTD., Tokyo (JP)

(72) Inventor: Satoshi Honma, Bangkok (TH)

(21) Appl. No.: 16/595,682

(22) Filed: Oct. 8, 2019

(30) Foreign Application Priority Data
Oct. 12, 2018 (JP) 2018-193452

(51) Int. Cl. G06Q 30/06; G06Q 30/02; G06Q 50/30

(52) U.S. Cl. CPC G06Q 30/0645; G06Q 50/30; G06Q 30/0627; G06Q 30/0284

(57) ABSTRACT

Provided is a rental management system including a first acquirer that acquires rental conditions and vehicle information including information of additional facilities of a vehicle from an owner who rents the vehicle to a user, a second acquirer that acquires usage conditions from a user who borrows a vehicle, a matching processor that matches between a vehicle and a user on the basis of the rental conditions and the usage conditions, and an incentive rate determiner that determines an incentive rate that is a rate of an amount paid to the owner with respect to a rental fee determined on the basis of the vehicle information, on the basis of at least information of additional facilities of the vehicle.

### CROSS-REFERENCE TO RELATED APPLICATION

Priority is claimed on Japanese Patent Application No. 2018-193452, filed Oct. 12, 2018, the content of which is incorporated herein by reference.

### BACKGROUND

### Field of the Invention

The present invention relates to a rental management system, a rental management method, and a storage medium.

### Description of Related Art

In the past, a technique for presenting information of a rental bicycle consistent with a bicycle with conditions desired by a user in a bicycle sharing service has been disclosed (Japanese Unexamined Patent Application, First Publication No. 2018-063469).

### SUMMARY

In the technique of the related art, an attempt to increase the motivation of an owner who performs rental has been lacking.

The present invention was contrived in view of such circumstances, and one object thereof is to provide a rental management system, a rental management method, and a storage medium which make it possible to increase a motivation to rent a vehicle.

A rental management system, a rental management method, and a storage medium according to this invention have the following configurations adopted therein.

(1) According to an aspect of this invention, there is provided a rental management system including: a rental conditions acquirer that acquires rental conditions and vehicle information including information of additional facilities of a vehicle from a terminal used by an owner who rents the vehicle to a user; a usage conditions acquirer that acquires usage conditions from a terminal used by a user who borrows a vehicle; a matching processor that matches between a vehicle and a user on the basis of the rental conditions and the usage conditions; and an incentive rate determiner that determines an incentive rate that is a rate of an amount paid to the owner with respect to a rental fee determined on the basis of the vehicle information, on the basis of at least information of additional facilities of the vehicle.

(2) In the aspect of the above (1), the incentive rate determiner further determines the incentive rate on the basis of the rental conditions.

(3) In the aspect of the above (2), the incentive rate determiner determines the incentive rate on the basis of a demand and supply balance obtained from a relationship between the rental conditions and the usage conditions.

(4) In the aspect of the above (3), the incentive rate determiner determines the incentive rate on the basis of a demand and supply balance obtained from past performance information.

(5) In the aspect of the above (3), the incentive rate determiner determines the incentive rate on the basis of a demand and supply balance reflecting a current user's desire.

(6) In the aspect of the above (2), the incentive rate determiner determines the incentive rate on the basis of a relationship between a user's desired date of use and a date on which the rental conditions are consistent with the usage conditions.

(7) In the aspect of the above (1), a user-oriented service information provider that provides service information to the terminal used by the user is further included, and the user-oriented service information provider provides the user with a result obtained by searching for elements included in the vehicle information as search keys.

(8) In the aspect of the above (1), a user-oriented service information provider that provides service information to the terminal used by the user is further included, and the user-oriented service information provider acquires a purpose of using the vehicle from the user, specifies additional facilities recommended on the basis of the acquired purpose, and provides the user with a vehicle including the specified additional facilities.

(9) According to another aspect of the present invention, there is provided a rental management method including causing a rental management system to: acquire rental conditions and vehicle information including information of additional facilities of a vehicle from a terminal used by an owner who rents the vehicle to a user; acquire usage conditions from a terminal used by a user who borrows a vehicle; match between a vehicle and a user on the basis of the rental conditions and the usage conditions; and determine an incentive rate that is a rate of an amount paid to the owner with respect to a rental fee determined on the basis of the vehicle information, on the basis of at least information of additional facilities of the vehicle.

(10) According to another aspect of the present invention, there is provided a storage medium having a program stored therein, the program causing one or more computers constituting a rental management system to: acquire rental conditions and vehicle information including information of additional facilities of a vehicle from a terminal used by an owner who rents the vehicle to a user; acquire usage conditions from a terminal used by a user who borrows a vehicle; match between a vehicle and a user on the basis of the rental conditions and the usage conditions; and determine an incentive rate that is a rate of an amount paid to the owner with respect to a rental fee determined on the basis of the vehicle information, on the basis of at least information of additional facilities of the vehicle.

According to the aspects of the above (1) to (10), it is possible to increase a motivation to rent a vehicle.

### BRIEF DESCRIPTION OF THE DRAWINGS

FIG. 1 is a diagram illustrating an example of usage environment of a rental management system.

FIG. 2 is a diagram illustrating an example of a configuration of a front-end server and a management device.

FIG. 3 is a diagram illustrating an example of a screen of an owner-oriented website.

FIG. 4 is a diagram illustrating an example of a screen of a user-oriented website.

FIG. 5 is a diagram illustrating an example of a screen representing a list of vehicles of a corresponding type.

FIG. 6 is a diagram illustrating an example of a screen representing a list of vehicles including corresponding additional facilities.

FIG. 7 is a diagram illustrating an example of a screen for recommending vehicles having additional facilities according to purpose of use.

FIG. 8 is a first flow chart illustrating an example of a flow of processes executed by the rental management system.

FIG. 9 is a diagram illustrating an example of content of purpose and facility correspondence information.

FIG. 10 is a second flow chart illustrating an example of a flow of processes executed by the rental management system.

FIG. 11 is a diagram illustrating an example of a relationship between a desired date of use and an incentive rate.

### DESCRIPTION OF EMBODIMENTS

### Outline

Hereinafter, an embodiment of a rental management system, a rental management method, and a program of the present invention will be described with reference to the accompanying drawings. A rental management system is operated in a form in which, instead of an operator of a rent-a-car service renting vehicles possessed by the operator as in the related art (or, in addition thereto), an owner who is a general user rents out a vehicle, and a user borrows this vehicle. In this case, an operator accepts a rental fee from a user, and pays a value obtained by multiplying the rental fee by an incentive rate to an owner. The incentive rate is adjusted on the basis of various elements in a management device 100 as described below. Thereby, a rental management system 50 can increase a motivation for an owner to rent a vehicle. An “owner” is also a “user” of the rental management system in a broad sense, but in the present specification, a “user” is assumed to refer to a “user who borrows a vehicle.”

### Overall Configuration

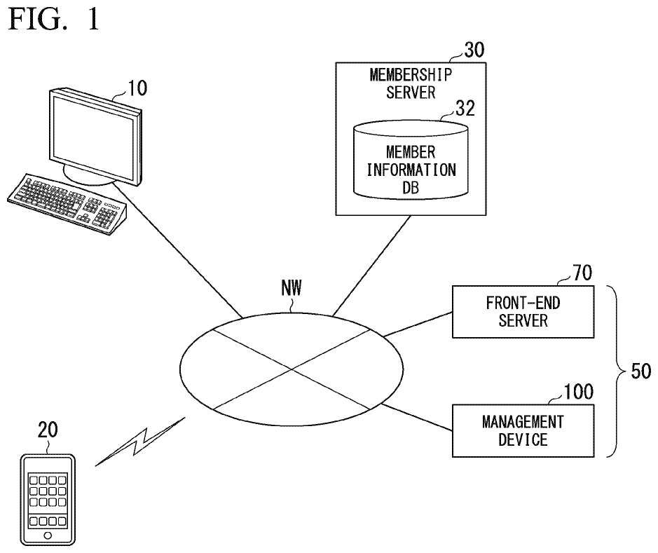

FIG. 1 is a diagram illustrating an example of usage environment of the rental management system 50. The rental management system 50 includes, for example, a front-end server 70 and a management device 100. An owner terminal 10, a user terminal 20, a membership server 30, the front-end server 70, and the management device 100 which are shown in the drawing communicate with each other through a network NW. One owner terminal 10 and one user terminal 20 are shown, but a plurality of owner terminals 10 and a plurality of user terminals 20 may use the rental management system 50. The network NW includes, for example, the Internet, a cellular network, a Wi-Fi network, a provider terminal, a wide area network (WAN), a local area network (LAN), or the like. In the example of FIG. 1, the front-end server 70 and the management device 100 are shown as being formed separately from each other, but they may be integrated and aggregated in one device.

The owner terminal 10 and the user terminal 20 are each realized by, for example, a personal computer, a smartphone, a tablet terminal or the like, that is, a computer device having a display function, an input acceptance function, a communication function or the like. In the owner terminal 10 and the user terminal 20, an interface of a browser, an application program or the like is started up, and various services for an owner or a user to use the rental management system 50 are provided.

The membership server 30 is a device that, for example, when an owner purchases a vehicle, accepts registration of the owner and information relating to the vehicle (such as the type of vehicle or additional facilities) to hold the accepted registration as member information DB 32 in a storage device, and refers to the member information DB 32 to return information when various types of services are provided from a service provider, an automobile manufacturer or the like to the owner.

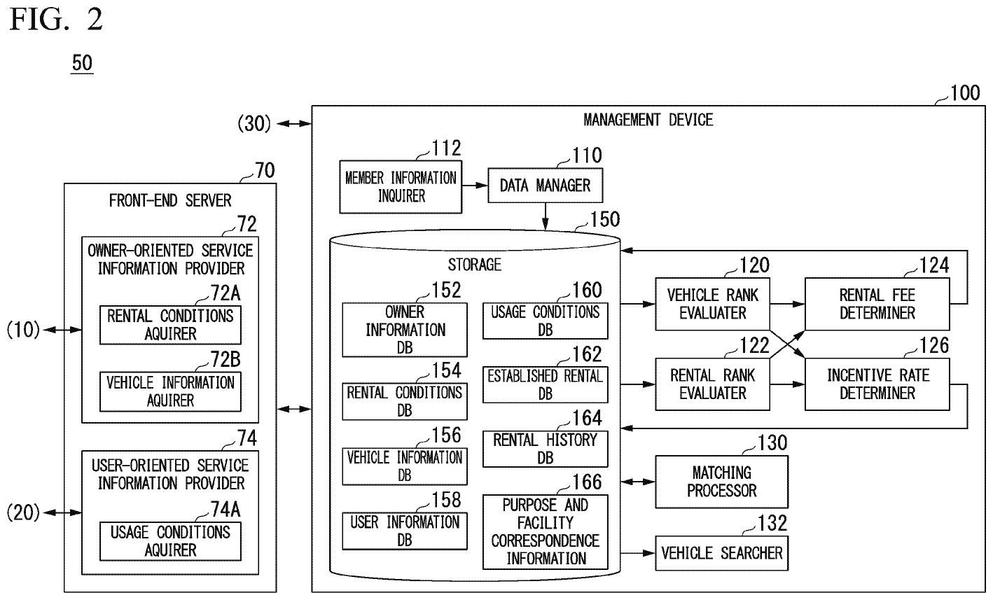

FIG. 2 is a diagram illustrating an example of a configuration of the front-end server 70 and the management device 100. Among components of the front-end server 70 and the management device 100 shown in the drawing, various components except a storage 150 of the management device 100 are realized by a hardware processor such as, for example, a central processor (CPU) executing a program (software). Some or all of these components may be realized by hardware (circuit unit; including circuitry) such as a large scale integration (LSI), an application specific integrated circuit (ASIC), a field-programmable gate array (FPGA), or a graphics processor (GPU), and may be realized by cooperation between software and hardware. The program may be stored in a storage device (a storage device including a non-transitory storage medium) such as a hard disk drive (HDD) or a flash memory in advance, may be stored in a detachable storage medium such as a DVD or a CD-ROM (a non-transitory storage medium), and may be installed by the storage medium being mounted in a drive device.

### Front-End Server and its Provided Service

The front-end server 70 includes, for example, an owner-oriented service information provider 72 and a user-oriented service information provider 74.

The owner-oriented service information provider 72 provides an owner-oriented website to the owner terminal 10. The owner-oriented service information provider 72 includes, for example, a rental conditions acquirer 72A and a vehicle information acquirer 72B. The owner-oriented service information provider 72 acquires various types of owner information during of registration of an owner.

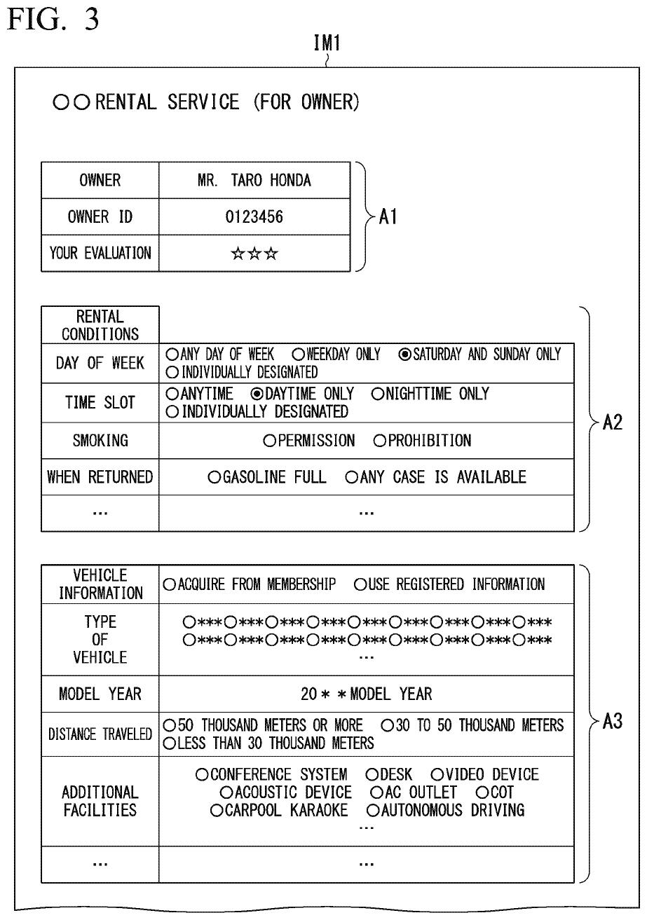

FIG. 3 is a diagram illustrating an example of a screen IM1 of an owner-oriented website. This drawing shows, for example, a screen that is displayed by the owner terminal 10 after an owner ID imparted in advance has logged in. As shown in the drawing, the screen IM1 of an owner-oriented website enables various types of inputs. For example, the screen IM1 includes an area A1 that displays an owner name, an owner ID, an evaluation for an owner, or the like. Information displayed in the area A1 is information acquired from an owner information DB 152 in the management device 100.

The screen IM1 includes an area A2 for inputting rental conditions. The owner operates a radio button or the like provided in the area A2, and thus can designate rental conditions such as a rentable day of the week, a time slot, whether to permit smoking, a refueling state (the SOC of a battery in the case of an electric automobile) when returned, a district in which use is possible and a delivery place (not shown), and the like. The rental conditions aquirer 72A acquires information designated in the area A2 as rental conditions, and sends the information to the management device 100.

The screen IM1 further includes an area A3 for inputting vehicle information. The owner operates a radio button or the like provided in the area A3, and thus can input information such as a type of vehicle, a model year, a distance traveled, or additional facilities. Examples of the additional facilities include a conference system, a desk, a video device, an acoustic device, an AC outlet, a cot, carpool karaoke, autonomous driving, or the like. In the area A3, in a case where “acquire from membership” is designated, information read out from the member information DB 32 held by the membership server 30 is sent to the management device 100, and thus an input of the type of vehicle or the like can be omitted. In a case where “use registered information” is designated, information registered before the previous time is cited, and thus an input of the type of vehicle or the like can be omitted. The vehicle information acquirer 72B acquires information which is input in the area A3 as vehicle information, and sends the information to the management device 100. In a case where “acquire from membership” or “use registered information” is designated, the vehicle information acquirer 72B sends information indicating to that effect to the management device 100.

The owner-oriented service information provider 72 accepts the owner's evaluation of a user after the rental has been terminated, and transmits the evaluation to the management device 100.

The user-oriented service information provider 74 provides a user-oriented website to the user terminal 20. The user-oriented service information provider 74 includes, for example, a usage conditions acquirer 74A. The user-oriented service information provider 74 acquires, for example, various types of user information during registration of a user.

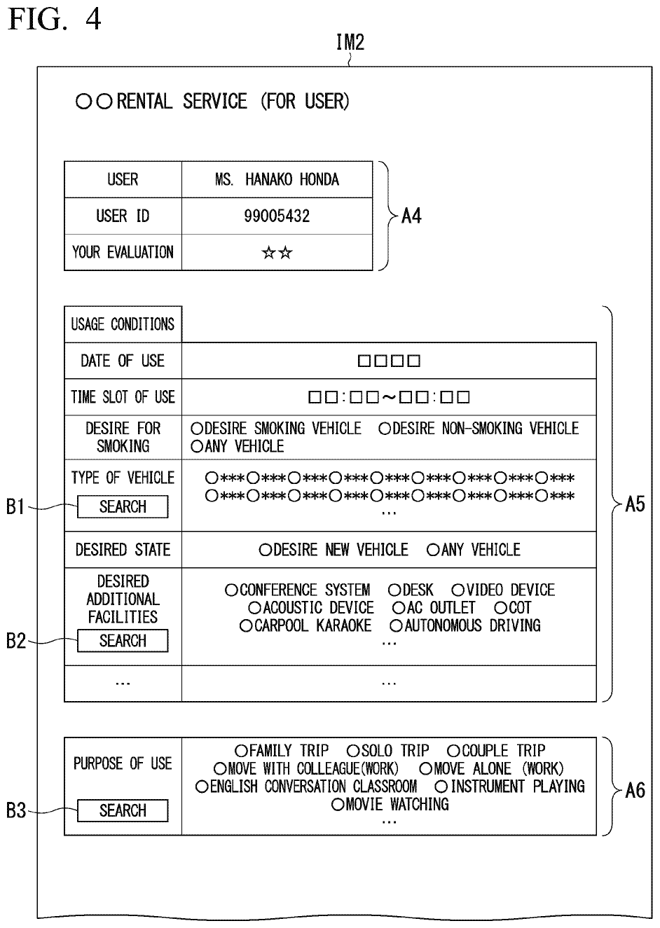

FIG. 4 is a diagram illustrating an example of a screen IM2 of a user-oriented website. This drawing shows, for example, a screen that is displayed by the user terminal 20 after a user ID imparted in advance has logged in. For example, the screen IM2 includes an area A4 that displays a user name, a user ID, an evaluation for a user, or the like. Information displayed in the area A4 is information acquired from a user information DB 158 in the management device 100.

The screen IM2 includes an area A5 for inputting usage conditions. The user performs text inputs, button operations or the like in the area A5, and thus can designate a date of use, a time slot of use, a desire for smoking, a type of vehicle, a desired state, desired additional facilities, a desired district of use and a desired district of delivery (not shown), and the like. The usage conditions acquirer 74A acquires information designated in the area A5 as usage conditions, and sends the information to the management device 100.

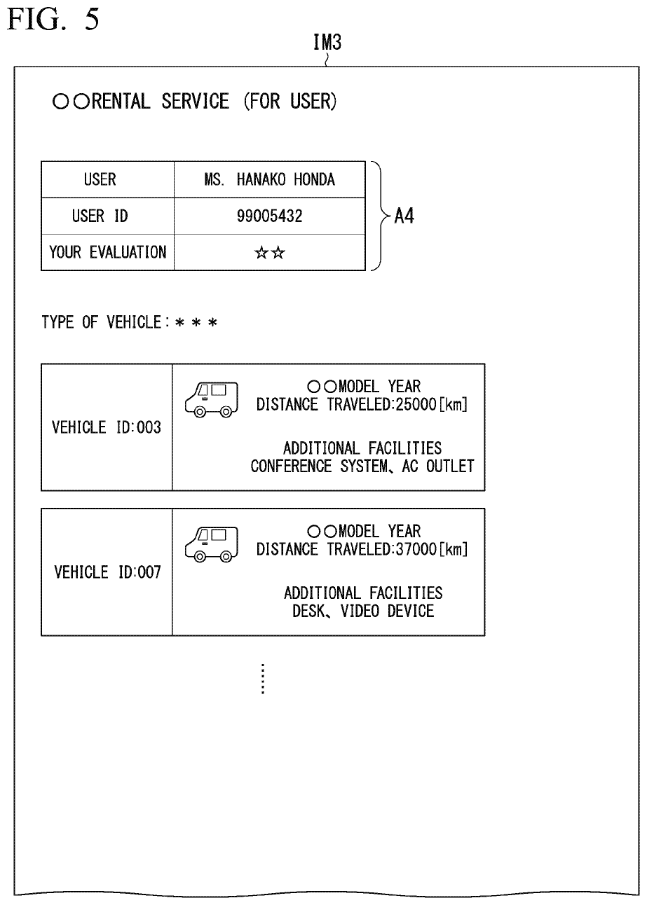

In the area A5, in a case where a search button B1 is operated in a state in which the type of vehicle is designated, a screen IM3 representing a list of vehicles of a corresponding type is displayed by the user terminal 20. FIG. 5 is a diagram illustrating an example of the screen IM3 representing a list of vehicles of a corresponding type. As shown in the drawing, in the screen IM3, information such as the model year, distance traveled, or additional facilities of a vehicle of a corresponding type is displayed in an area provided for each vehicle ID.

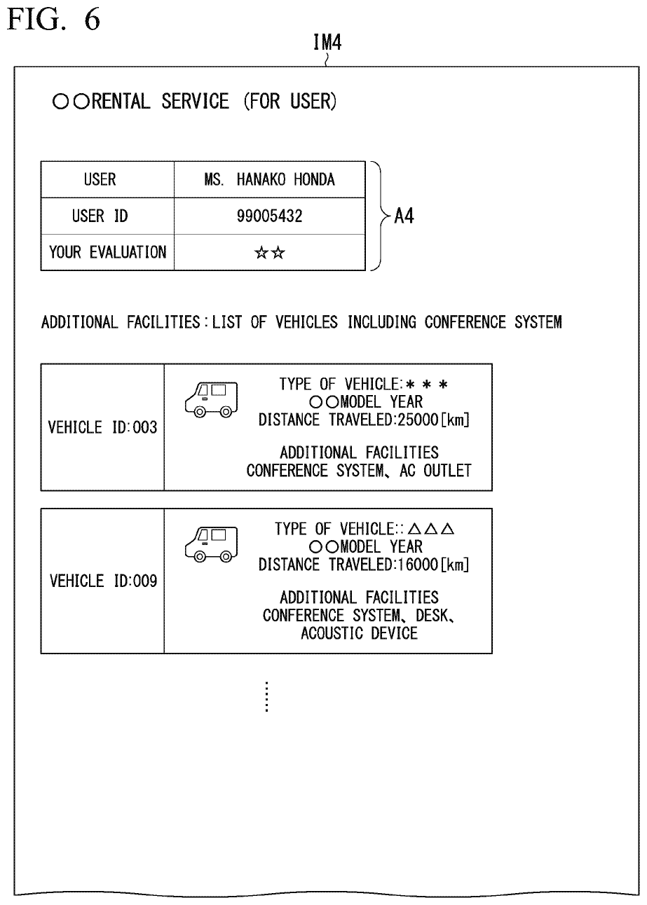

In the area A5, in a case where a search button B2 is operated in a state in which additional facilities are designated, a screen IM4 representing a list of vehicles including corresponding additional facilities is displayed by the user terminal 20. FIG. 6 is a diagram illustrating an example of the screen IM4 representing a list of vehicles including corresponding additional facilities. As shown in the drawing, in the screen IM4, information such as the type, model year, distance traveled, or additional facilities of a vehicle including corresponding additional facilities is displayed in an area provided for each vehicle ID.

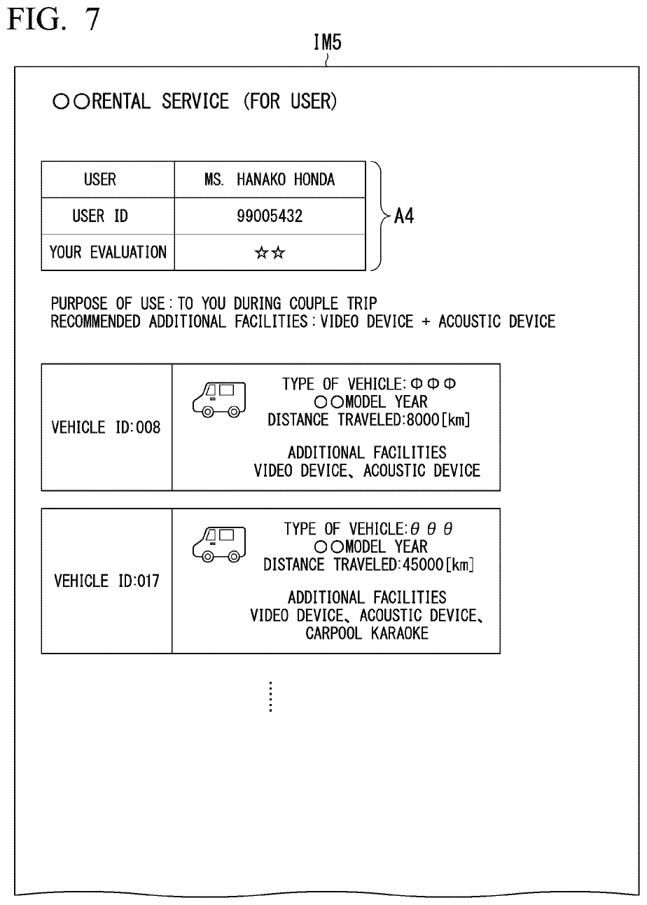

Referring back to FIG. 4, the screen IM2 includes an area 6 for inputting purpose of use. The purpose of use is more abstract ambiguous information such as “family trip” or “solo trip” without directly designating the type of vehicle or additional facilities. A designated item or an input item as the purpose of use may represent what a user wants to experience or activities that can be conducted in the interior of a vehicle such as “English conversation classroom” intended for language learning or “instrument playing” for using the interior of a vehicle as a studio, or “movie watching” for the purpose of enjoying a movie in the interior of a vehicle. In a case where a search button B3 is operated in a state in which the purpose of use is designated, vehicles having additional facilities according to the purpose of use are recommended. FIG. 7 is a diagram illustrating an example of a screen IM5 for recommending vehicles having additional facilities according to purpose of use. As shown in the drawing, in the screen IM5, information such as the type, model year, distance traveled, or additional facilities of a vehicle including additional facilities (recommended additional facilities) selected in the management device 100 in accordance with the purpose of use is displayed in an area provided for each vehicle ID.

In a case where a column of one vehicle is selected in the screens IM3 to IM5, more detailed information such as rental conditions may be displayed. In a case where a user directly designates a vehicle in this state, processing of a matching processor 130 to be described later is not necessary.

When the screens IM3 to IM5 are provided, the user-oriented service information provider 74 requests the management device 100 to search for necessary information. The management device 100 perform processing such as a search in accordance with a request from the user-oriented service information provider 74, and returns a processing result to the front-end server 70. Processing on the management device 100 side will be described below.

The user-oriented service information provider 74 accepts a user's evaluation of a vehicle (owner) after the rental has been terminated, and transmits the evaluation to the management device 100.

### Management Device

Referring back to FIG. 2, the management device 100 includes, for example, a data manager 110, a member information inquirer 112, a vehicle rank evaluater 120, a rental rank evaluater 122, a rental fee determiner 124, an incentive rate determiner 126, a matching processor 130, a vehicle searcher 132, and a storage 150. The storage 150 stores data such as the owner information DB (database) 152, a rental conditions DB 154, a vehicle information DB 156, the user information DB 158, a usage conditions DB 160, an established rental DB 162, a rental history DB 164, or a purpose and facility correspondence information 166.

The data manager 110 registers the owner information, the rental conditions, the vehicle information, the user information, or the usage conditions acquired in the front-end server 70 with the owner information DB 152, the rental conditions DB 154, the vehicle information DB 156, the user information DB 158, or the usage conditions DB 160, respectively.

In a case where “acquire from membership” is selected in the area A3 of the screen IM1, the member information inquirer 112 queries the membership server 30 to acquire information such as the type of vehicle of an owner included in the member information DB 32, and delivers the information to the data manager 110. The data manager 110 registers the information acquired from the member information inquirer 112 with the owner information DB 152 or the vehicle information DB 156.

Processes of the vehicle rank evaluater 120, the rental rank evaluater 122, the rental fee determiner 124, and the incentive rate determiner 126 are executed, for example, when rental conditions and vehicle information are registered by an owner that is a target (hereinafter referred to as a target owner).

The vehicle rank evaluater 120 determines a primary rental fee and a primary incentive rate as a base with respect to a target owner on the basis of the vehicle information registered with the vehicle information DB 156.

The vehicle rank evaluater 120 calculates, for example, a primary rental fee Rf1 on the basis of Expression (1). Herein, F( ) is a function of returning a value corrected to be higher as the model year becomes newer and corrected to be higher as the distance traveled becomes shorter on the basis of a basic rental fee determined for each type of vehicle. Ro(k) is an additional fee that is set in advance for each additional facility, and an additional fee corresponding to a k-th additional facility among additional facilities to which pieces of identification information of 1 to n are imparted. The additional fee Ro(k) may be a specified value determined in advance by an operator of the rental management system 50, but may be a value evaluated in a feedback manner on the basis of a rate (a degree of popularity) included in the acquired usage conditions, an evaluation or comment after a user's use, and the like.

Rf1=F(type of vehicle, model year, distance traveled)+Σₖ₌₁ⁿRo(k) )1)

The vehicle rank evaluater 120 calculates, for example, a primary incentive rate Ir1 on the basis of Expression (2). Herein, Iset is a basic incentive rate determined in advance. G( ) is a function of returning a higher value as the type of vehicle becomes rarer. Iro(k) is an additional incentive rate that is set in advance for each additional facility, and is an additional incentive rate corresponding to a k-th additional facility among additional facilities to which pieces of identification information of 1 to n are imparted. The additional incentive Iro(k) may be a specified value determined in advance by an operator of the rental management system 50, but may be a value evaluated in a feedback manner on the basis of a rate (that is, a degree of popularity) desired in the usage conditions, an evaluation or comment after a user's use, and the like. The additional fee Ro(k) and the additional incentive Iro(k) may be set to values independent of each other, but may be set to have a dependency relation. For example, the additional incentive Iro(k) may be obtained using a method of multiplying the additional fee Ro(k) by a coefficient, or the like.

Ir1=Iset+G(type of vehicle)+ₖ₌₁ⁿIro(k) (2)

The rental rank evaluater 122 determines adjusted values K_{Rf} and K_{Ir} for adjusting a primary rental fee and a primary incentive rate. The rental rank evaluater 122 determines the adjusted values K_{Rf} and K_{Ir} on the basis of a demand and supply balance obtained from a relationship between the rental conditions and the usage conditions using the following (Method 1) or (Method 2), or a combination thereof. The adjusted values K_{Rf} and K_{Ir} are, for example, values in which 1 is set as an initial value, and which are corrected to values equal to or greater than 1 every time a point is added. The adjusted values K_{Rf} and K_{Ir} may be corrected to values less than 1 in a case where these values do not include an element that makes a high contribution to rental establishment.

(Method 1)

The rental rank evaluater 122 determines the adjusted values K_{Rf} and K_{Ir} so as to increase a primary rental fee and a primary incentive rate in the case of rental conditions according to the past user's desire on the basis of the rental conditions DB 154 and the rental history DB 164. That is, the rental rank evaluater 122 determines the adjusted values K_{Rf} and K_{Ir} on the basis of a demand and supply balance obtained from the past performance information. The rental history DB 164 is, for example, a database in which a date of use and the day of the week in a case where rental is established, a time slot of use, smoking permission or prohibition setting, the type of vehicle, additional facilities, and the like are registered as one record. For example, the rental rank evaluater 122 analyzes the rental history DB 164 for each element, and extracts an element that makes a high contribution to rental establishment. Specifically, in a case where rental on Saturdays and Sundays is significantly more frequent than on weekdays, the rental rank evaluater 122 determines that an element of “dates of use are Saturdays and Sundays” makes a high contribution to rental establishment. In a case where the rental conditions of a target owner include an element, extracted in this manner, which makes a high contribution to rental establishment, the rental rank evaluater 122 determines the adjusted values K_{Rf} and K_{Ir} by adding a point for each element.

(Method 2)

The rental rank evaluater 122 determines the adjusted values K_{Rf} and K_{Ir} so as to increase a primary rental fee and a primary incentive rate in the case of rental conditions close to presently desired usage conditions on the basis of the rental conditions DB 154 and the usage conditions DB 160. That is, the rental rank evaluater 122 determines the adjusted values K_{Rf} and K_{Ir} on the basis of a demand and supply balance reflecting a current user's desire. The usage conditions DB 160 is a database obtained by collecting information before rental is established among usage conditions which are input by a user. In a case where the rental conditions of a target owner include an element of usage conditions having a high number of occurrences in the usage conditions DB 160, the rental rank evaluater 122 determines the adjusted values K_{Rf} and K_{Ir} by adding a point for each element.

The rental fee determiner 124 determines a rental fee relating to a target owner on the basis of, for example, the primary rental fee Rf1 and the adjusted value K_{Rf}. For example, the rental fee determiner 124 determines a rental fee Rf by multiplying the primary rental fee Rf1 and the adjusted value K_{Rf} together as shown in Expression (3).

Rf=Rf1×K_{Rf} (3)

The incentive rate determiner 126 determines an incentive rate relating to a target owner on the basis of, for example, the primary incentive rate Ir1, the adjusted value K_{Ir}, and the owner information DB 152. In the owner information DB 152, in addition to information which is input by an owner or acquired from the membership server 30, the evaluation of the owner based on a feedback evaluation from a user who uses the owner's vehicle is associated with an owner ID. For example, the incentive rate determiner 126 determines an incentive rate Ir by multiplying the primary incentive rate Ir1, the adjusted value K_{Ir}, and an evaluation value Es obtained by digitizing the evaluation of the owner together as shown in Expression (4). The evaluation value Es becomes a greater value as the evaluation becomes better.

Ir=Ir1×K_{If}×Es (4)

In this manner, according to the management device 100, an incentive rate is determined in accordance with additional facilities of a vehicle. As a result, since an owner who has mounted additional facilities in a vehicle at a greater cost can acquire a higher incentive, it is possible to reduce a burden of a maintenance fee such as the loan of the owner's vehicle. Therefore, it is possible to increase a motivation for the owner to rent a vehicle. Even in a case where an expensive vehicle is purchased, a burden after the purchase is reduced, and thus it is possible to arouse a motivation to purchase a vehicle having ample additional facilities.

According to the management device 100, an incentive rate is set to be high in a case where rental conditions meet a user's needs. As a result, it is possible to urge an owner to perform rental in conditions having high needs, and to increase the possibility of rental establishment.

According to the management device 100, an incentive rate is determined by reflecting a user's evaluation of an owner. Therefore, a high incentive rate is set in a case where an owner appropriately maintains additional facilities of a vehicle, and thus an appropriate incentive can be paid in accordance with the state of the vehicle, the quality of the additional facilities, or the like.

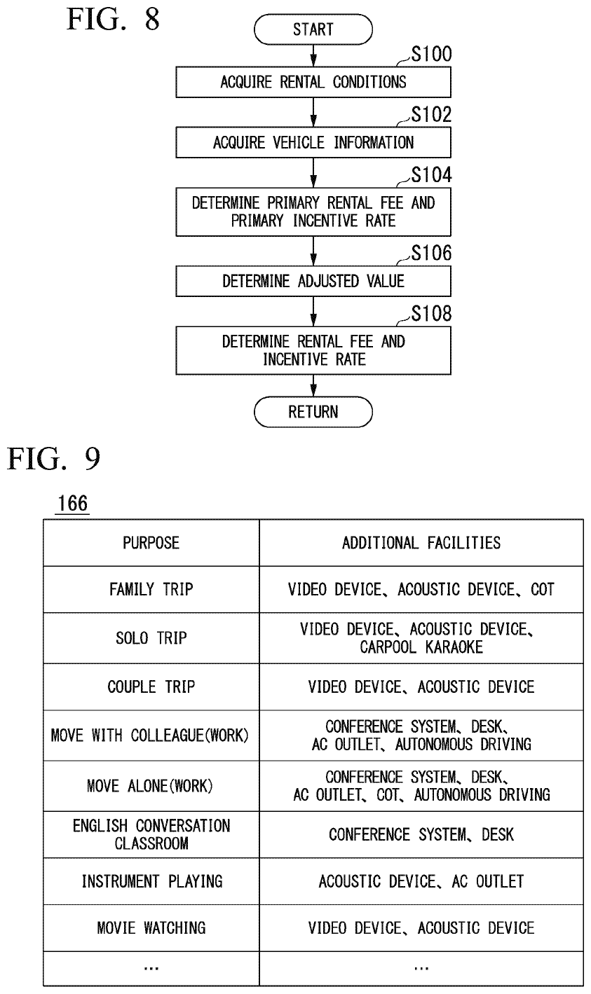

FIG. 8 is a first flow chart illustrating an example of a flow of processes executed by the rental management system 50. First, the rental conditions acquirer 72A acquires rental conditions from the owner terminal 10 (step S100), and the vehicle information acquirer 72B acquires vehicle information from the owner terminal 10 (step S102). The information is provided to the management device 100.

Next, the vehicle rank evaluater 120 determines a primary rental fee and a primary incentive (step S104), and the rental rank evaluater 122 determines an adjusted value. The rental fee determiner 124 then determines a rental fee, and the incentive rate determiner 126 determines an incentive rate (step S108).

The matching processor 130 searches for a vehicle (owner) having rental conditions and vehicle information of content that is consistent with each record registered with the usage conditions DB 160 on the basis of the rental conditions DB 154, the vehicle information DB 156, and the usage conditions DB 160. In a case where a consistent vehicle is found, the matching processor 130 deletes the record from the usage conditions DB 160, and registers the record with the established rental DB 162. In this case, identification information of an owner and a vehicle, identification information of a user, a date of use, a time slot of use, and other established information are registered with the established rental DB 162. In a case where the date of use passes, the matching processor 130 transcribes content registered with the established rental DB 162 into the rental history DB 164.

The matching processor 130 reflects a user's evaluation of a vehicle (owner) acquired from the front-end server 70 after rental in the evaluation of the owner in the owner information DB 152. The matching processor 130 reflects the owner's evaluation of the user acquired from the front-end server 70 after rental in the evaluation of the user in the user information DB 158. A known technique may be used in updating an evaluation, and thus the detailed description thereof will not be given.

The vehicle searcher 132 executes a search process for a vehicle used in various services which are provided by the user-oriented service information provider 74. As described with reference to FIGS. 3 to 7, a user is provided with services of a search in which a type of vehicle is designated, a search in which additional facilities are designated, and a search in which a purpose is designated. In a case where a search in which the type of vehicle or the additional facilities are designated is performed, the vehicle searcher 132 searches the vehicle information DB 156 using designated information as a search key. The vehicle information DB 156 has information such as a type of vehicle, a model year, a distance traveled, or additional facilities associated with a vehicle ID. The vehicle searcher 132 returns a search result to the front-end server 70. In the front-end server 70, the user-oriented service information provider 74 generates a screen based on the search result and transmits the generated screen to the user terminal 20. Thereby, a screen obtained by reflecting the search result is displayed on the user terminal 20, and is provided to a user.

In a case where a search in which a purpose is designated is requested, the vehicle searcher 132 first refers to the purpose and facility correspondence information 166, and specifies additional facilities appropriate for the purpose. FIG. 9 is a diagram illustrating an example of content of the purpose and facility correspondence information 166. As shown in the drawing, the purpose and facility correspondence information 166 is information in which recommended additional facilities are described with respect to the “purpose” of vehicle use which is accepted by the user-oriented service information provider 74. The vehicle searcher 132 searches the vehicle information DB 156 using specified additional facilities as search keys. The vehicle searcher 132 returns a search result to the front-end server 70. In the front-end server 70, the user-oriented service information provider 74 generates a screen based on the search result and transmits the generated screen to the user terminal 20. Thereby, a screen obtained by reflecting the search result is displayed on the user terminal 20, and is provided to a user.

In this manner, the rental management system 50 presents recommended additional facilities not only in a case where additional facilities are specifically designated, but also in a case where a more ambiguous “purpose” is designated, and further searches for a vehicle having the additional facilities to present the vehicle to a user. Thereby, it is possible to increase a user's convenience, and to propose the enjoyment of drive which is unexpected by a user at first.

The rental management system 50 not only may propose a vehicle by specifying additional facilities recommended on the basis of a purpose, but also may propose a vehicle by specifying a type of vehicle recommended on the basis of the purpose.

FIG. 10 is a second flow chart illustrating an example of a flow of processes executed by the rental management system 50. First, the user-oriented service information provider 74 accepts a search instruction from the user terminal 20 (step S200). The content of the instruction is provided to the management device 100.

In the management device 100, the vehicle searcher 132 determines whether an instruction for a search in which a “purpose” is designated is performed (step S202). In a case where an instruction for a search in which a “purpose” is designated is performed, the vehicle searcher 132 refers to the purpose and facility correspondence information 166, and specifies recommended additional facilities (step S204). The vehicle searcher 132 then searches the vehicle information DB 156 using the content of an instruction handed over from the front-end server 70 or the additional facilities specified in step S204 as search keys (step S206), and returns a search result to the front-end server 70. In the front-end server 70, the user-oriented service information provider 74 provides a screen to the user terminal 20 on the basis of the search result (step S208).

According to the embodiment described above, it is possible to increase a motivation to rent a vehicle.

### Other Embodiments

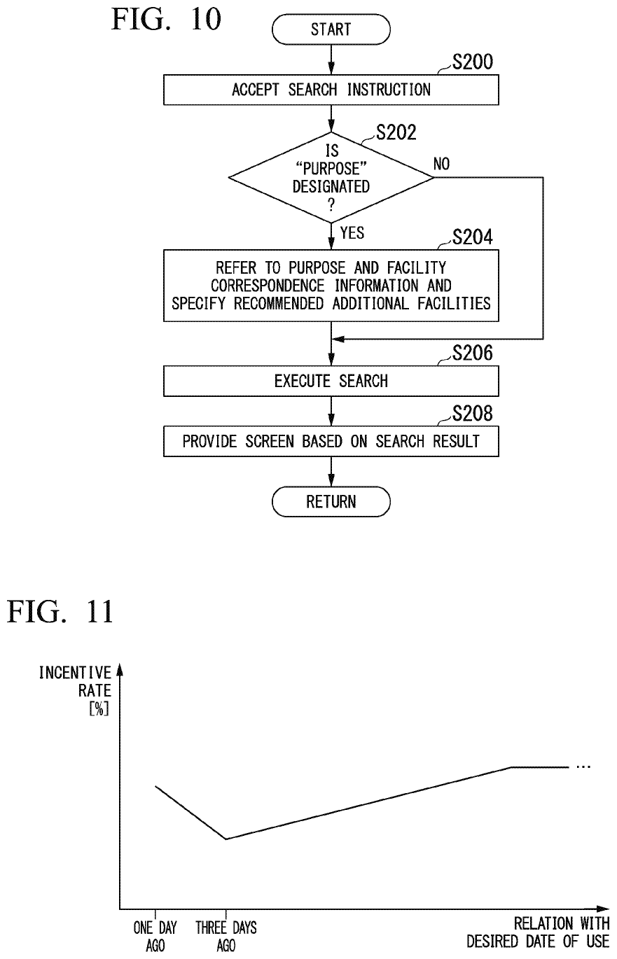

In the above embodiment, the rental fee and the incentive rate have been described as being set independently of the date of use. Instead, the incentive rate may be set in relation to a desired date of use designated by a user. In this case, for example, a notification is sent to an owner who possesses a vehicle that meets usage conditions, or an owner for whom rental conditions are not consistent with the usage conditions. A list of the usage conditions may be able to be viewed by the owner side. In a case where the owner changes the rental conditions so as to be consistent with the usage conditions (or in a case where rental conditions are newly set so as to be consistent with the usage conditions), the incentive rate is determined in accordance with a relationship between a date of change and a desired date of use. For example, the incentive rate is set to be high in a case where the rental conditions are changed at an earlier timing. However, in order to avoid, if possible, a situation in which a vehicle is not able to be borrowed immediately before a desired date of use, the incentive rate may be increased as the desired date of use approaches from immediately before the desired date of use (after the number of predetermined days ago). FIG. 11 is a diagram illustrating an example of a relationship between a desired date of use and an incentive rate. In this manner, it is possible to reduce the possibility of occurrence of a situation in which rental vehicles are not found.

The above-described incentive may be paid to an owner by cash, but may be filled in more favorable conditions than payment by cash in, for example, the payment of a loan of a vehicle. An owner who has purchased a vehicle by residual value credit may be paid an incentive by addition to the amount of purchase when the vehicle is surrendered, and may be given a deduction from the amount of purchase at the time of the next purchase of a vehicle. This makes it possible to save a complicate attempt to accept cash.

After the rental of a vehicle is established by the matching processor 130, the user-oriented service information provider 74 may cause the user terminal 20 to display an advertisement relevant to use of a vehicle until the date of use. The advertisement relevant to use of a vehicle is an advertisement of commercial facilities of a desired district of use, an advertisement of a vehicle itself to be rented, or the like. In this case, the rental management system 50 may previously acquire consent relating to a targeting advertisement from a user, and impart the user some kind of benefit according to display of the advertisement.

In the above embodiment, the rental fee is assumed to be determined regardless of an owner's desired amount, but may be determined by reflecting the owner's desired amount. Further, when the rental fee is determined, an element of auction may be introduced.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A rental management system comprising:
a first acquirer that acquires rental conditions and vehicle information including information of additional facilities of a vehicle from a terminal used by an owner who rents the vehicle to a user;
a second acquirer that acquires usage conditions from a terminal used by a user who borrows a vehicle;
a matching processor that matches between a vehicle and a user on the basis of the rental conditions and the usage conditions; and
an incentive rate determiner that determines an incentive rate that is a rate of an amount paid to the owner with respect to a rental fee determined on the basis of the vehicle information, on the basis of at least information of additional facilities of the vehicle.

2. The rental management system according to claim 1,
wherein the incentive rate determiner further determines the incentive rate on the basis of the rental conditions.

3. The rental management system according to claim 2,
wherein the incentive rate determiner determines the incentive rate on the basis of a demand and supply balance obtained from a relationship between the rental conditions and the usage conditions.

4. The rental management system according to claim 3,
wherein the incentive rate determiner determines the incentive rate on the basis of a demand and supply balance obtained from past performance information.

5. The rental management system according to claim 3,
wherein the incentive rate determiner determines the incentive rate on the basis of a demand and supply balance reflecting a current user's desire.

6. The rental management system according to claim 2,
wherein the incentive rate determiner determines the incentive rate on the basis of a relationship between a user's desired date of use and a date on which the rental conditions are consistent with the usage conditions.

7. The rental management system according to claim 1, further comprising a user-oriented service information provider that provides service information to the terminal used by the user,
wherein the user-oriented service information provider provides the user with a result obtained by searching for elements included in the vehicle information as search keys.

8. The rental management system according to claim 1, further comprising a user-oriented service information provider that provides service information to the terminal used by the user,
wherein the user-oriented service information provider acquires a purpose of using the vehicle from the user, specifies additional facilities recommended on the basis of the acquired purpose, and provides the user with a vehicle including the specified additional facilities.

9. A rental management method comprising:
acquiring rental conditions and vehicle information including information of additional facilities of a vehicle from a terminal used by an owner who rents the vehicle to a user;
acquiring usage conditions from a terminal used by a user who borrows a vehicle;
matching between a vehicle and a user on the basis of the rental conditions and the usage conditions; and
determining an incentive rate that is a rate of an amount paid to the owner with respect to a rental fee determined on the basis of the vehicle information, on the basis of at least information of additional facilities of the vehicle.

10. A computer readable non-transitory storage medium having a program stored therein, the program causing one or more computers constituting a rental management system to:
acquire rental conditions and vehicle information including information of additional facilities of a vehicle from a terminal used by an owner who rents the vehicle to a user;
acquire usage conditions from a terminal used by a user who borrows a vehicle;
match between a vehicle and a user on the basis of the rental conditions and the usage conditions; and
determine an incentive rate that is a rate of an amount paid to the owner with respect to a rental fee determined on the basis of the vehicle information, on the basis of at least information of additional facilities of the vehicle.
